(19) United States
(12) Patent Application Publication
(10) Pub. No.: US 2002/0071803 A1
(43) Pub. Date: Jun. 13, 2002

(54) Method of producing silicon carbide power

(75) Inventor: Gady Golan, Hod Hasharon (IL)

Correspondence Address: G. E. EHRLICH LTD., c/o ANTHONY CASTORINA, SUITE 207, 2001 JEFFERSON DAVIS HIGHWAY, ARLINGTON, VA, 22202, US

(73) Assignee: SILBID LTD.

(21) Appl. No.: 09/734,663

(22) Filed: Dec. 13, 2000

Related U.S. Application Data
(60) Provisional application No. 60/230,443, filed on Sep. 6, 2000.

(51) Int. Cl. C01B 31/36

(52) U.S. Cl. 423/345

(57) ABSTRACT

A method of producing finely-divided particles of silicon carbide (SiC), by introducing into a furnace a crucible containing a layer of finely-divided particles of carbon and a layer of finely-divided particles of elemental silicon separated by a layer permeable to silicon vapor; subjecting the interior of the furnace to a vacuum; and heating the crucible to a sufficiently high temperature for a sufficiently long period of time to vaporize and diffuse the silicon and to react the silicon vapor with the carbon particles to convert them to silicon carbide particles.

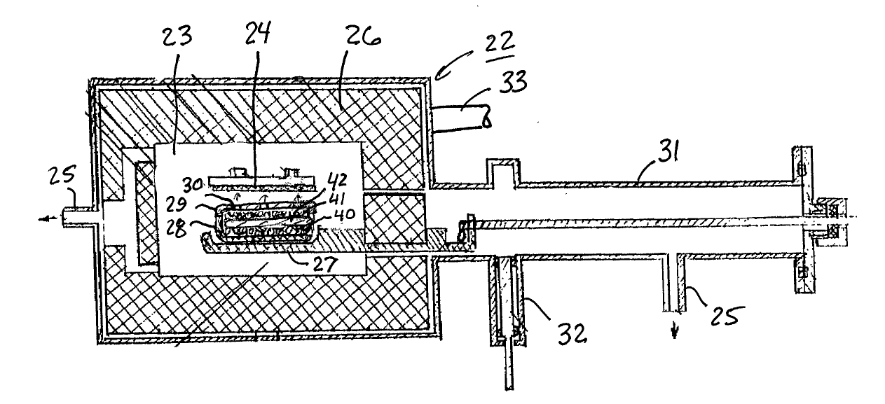

### RELATED APPLICATIONS

The present application is related to Provisional Application 60/230,443 filed Sep. 6, 2000, and claims the priority date of that application.

### FIELD AND BACKGROUND OF THE INVENTION

The invention in the present application relates to a novel method of producing silicon carbide (SiC), particularly finely-divided particles of silicon carbide, for use as abrasives, for hardening surfaces such as turbine blades, cutting implements, etc.

Silicon carbide (SiC), sometimes referred to as carborundum, is a hard, clear, green-tinged or yellow-tinged crystalline compound, which is normally insulating but which becomes conductive when properly heated at a high temperature; for example, when heated to 2000° C., it is as conductive as graphite. This material, therefore, is frequently classified as a semiconductor. It is presently used in a wide variety of applications, including abrasives, heating elements, illuminating elements, high-temperature sensors and semiconductor substrates. Because of its highly unique properties, particularly hardness, heat resistance, semiconductivity, thermal and electrical stability, and corrosion resistance, it is commonly considered as the material of the future.

Silicon carbide is generally manufactured, according to one known method, by heating pure silica sand and carbon in the form of coke in an electrical furnace.

According to another known method, a graphite heating element in a cylinder bar is covered with mixture of carbon powder and quartz and high electrical current is passed through it to create a temperature of up to 3000° C. At this temperature, the quartz (S₁0₂) is broken down to pure silicon, which reacts with the carbon powder and creates the required SiC. At a lower temperature zone, a distance from the heater, the SiC begins crystallizing in the shape of small scales. These scales are ground to form a powder of the required size. This process of SiC powder synthesis which takes place in a vacuum (10⁻³ Torr), requires in the order of 36 hours, as well as high electrical currents.

Approximately 45 years ago a new concept was proposed by Lely for growing silicon carbide crystals of high quality; and approximately 20 years ago, a seeded sublimation growth technique was developed (sometimes referred to as the “modified Lely Technique”). The latter technique lead to the possibility for true bulk crystal preparation.

However, these techniques are also relatively expensive and time-consuming, such that they impose serious limitations on the industrial potential of this remarkable material. Moreover, it is difficult to obtain a powder of the required grain size and/or uniformity with these known processes.

### OBJECTS AND BRIEF SUMMARY OF THE INVENTION

An object of the invention in the present application is to provide a new method of producing finely-divided particles of silicon carbide having advantages in one or more of the above respects.

According to a broad aspect of the present invention, there is provided a method of producing finely-divided particles of silicon carbide (SiC), comprising: introducing into a furnace a crucible containing a layer of finely-divided particles of carbon and a layer of finely-divided particles of elemental silicon separated by a layer permeable to silicon vapor; subjecting the interior of the furnace to a vacuum; and heating the crucible to a sufficiently high temperature for a sufficiently long period of time to vaporize and diffuse the silicon and to react the silicon vapor with the carbon particles to convert them to silicon carbide particles.

By elemental silicon is meant the silicon element, as distinguished from the silicon dioxide compound (e.g., sand, glass, quartz). Preferably, the silicon is relatively pure except for possible traces of impurities or dopants, such as present in silicon semiconductor substrates. In fact particularly good results were obtained, as described below, when the silicon used was the wastage in the manufacture of silicon semiconductor substrates.

Preferably, the carbon is either lignite carbon or anthracite carbon ground to a fine talc or power form.

During this heating process, the silicon vaporizes, diffuses into the carbon, and converts it to silicon carbide (SiC). Since silicon carbide has a green-tinged or yellow-tinged color, depending on impurities or dopants therein, the formation of such a color during the above-described heating process indicates that the resulting product is indeed silicon carbide.

Since the novel method utilizes elemental silicon, rather than S₁0₂ (as in sand, glass or quartz), it does not require the high temperatures (e.g., the order of 3000° C.), or the long heating time (e.g., the order of 36 hours) required on the prior art process as described above.

In the preferred embodiments of the invention described below, the quantity of silicon is in excess of the quantity of carbon by weight to assure relatively complete conversion of the carbon to silicon carbide, with the excess silicon being removed by removing the silicon vapors during the diffusion process to prevent or minimize condensation of the silicon vapor on the outer surface of the silicon carbide.

According to further features in the described preferred embodiments, the carbon and silicon are both contained in a graphite crucible when heated within the furnace. The crucible is at least partly open at its upper end to the interior of the furnace to permit excess silicon vapors to escape to the interior of the furnace, and thereby to prevent or minimize condensation of silicon vapors on the outer surface of the silicon carbide.

Further features and advantages of the invention will be apparent from the description below.

### BRIEF DESCRIPTION OF THE DRAWINGS

The invention is herein described, by way of example only, with reference to the accompanying drawing diagrammatically illustrating one form of apparatus for use in preparing silicon carbide powder in accordance with the method of the present invention.

### DESCRIPTION OF PREFERRED EMBODIMENTS

The apparatus illustrated in the drawing includes a furnace, generally designated 22, whose interior 23 is heated by a plurality of planar electrical heating elements 24. A pump (not shown) communicates with the interior 23 of the furnace via gas outlets 25, for producing a vacuum therein. The interior of the furnace is lined with graphite walls 26 for heat isolation.

Disposed within the interior 23 of the furnace is a table 27 for supporting a crucible 28 to receive the work materials which, when subjected to heat and vacuum as described below, produce silicon carbide powder. Crucible 28 is of hardened graphite. Its upper end is covered by a graphite lid 29 formed with openings 30 to provide communication between the interior of the crucible and the interior 23 of the furnace 22, as will be described more particularly below.

The work materials to be processed are introduced into the furnace via an insertion pipe 31. Pipe 31 includes the main gas outlet 25 connected to the vacuum pump, and also a vacuum valve 32. The furnace 22 further includes an electric feed-through 33 for supplying the electrical current to the heating elements.

Such electrical furnaces are well known, and therefore further details of its structure and the manner of operating it are not set forth herein.

Crucible 28 includes the silicon component in the form of finely-divided particles 40 placed at the bottom of the crucible. The carbon component is in the form of finely-divided particles shown at 41, separated from the silicon particles 40 by a layer 42 which is permeable to the silicon vapors produced during the heating process. Such vapors may therefore rise and react with the carbon particles 40 to produce the silicon carbide particles. Preferably, the carbon is either lignite carbon or anthracite carbon ground to a fine talc or power form. Layer 42 is preferably a hardened graphite cloth placed on the silicon particles with the carbon particles on the graphite cloth, such that the silicon vapors penetrate and diffuse with respect to the carbon particles to convert them to SiC.

The interior of the furnace 22, with the crucible 28 and the silicon particles 40, carbon particles 41, and permeable graphite cloth layer 42 therein, is subjected to a vacuum via gas outlets 25, and is heated by electrical heating elements 24. This heating of the interior of the furnace 23 is at a sufficiently high temperature, and for a sufficiently long period of time, until the particles within the crucible exhibit a green-tinged or yellow-tinged color, thereby indicating that the silicon particles 40 have vaporized, diffused into the carbon particles, and have converted the carbon particles to silicon carbide particles.

As indicated earlier, crucible lid 29 is provided with openings 30. This permits the silicon vapors to escape during the heating process into the interior 23 of the furnace, and thereby prevents or reduces the condensation and deposition of silicon vapors on the outer surface of the carbon particles.

Following are several examples for producing silicon carbide particles or powder using the illustrated apparatus.

### EXAMPLE 1

In this example, the carbon particles 41 are finely-divided particles of charcoal having a particle size of 50-250 microns; and the silicon particles 40 introduced in the bottom of the crucible 28 are finely-divided particles of relatively pure silicon obtained from the waste of silicon semiconductor wafers, both the mono-crystalline and the poly-crystalline type, resulting from the production of semiconductor devices and ground to a fine particle size. This example used a 10% excess of silicon particles by weight over the carbon particles, namely 1.0 kilogram of carbon particles and 1.10 kilogram of silicon particles. The silicon is relatively pure elemental silicon but may include traces of dopants or impurities as present in silicon semiconductor wafers.

The interior of the oven 23 is evacuated to a pressure of 10⁻³ Torr and heated to a temperature of 1550° C.-1600° C. for a period of 30 minutes. During this period, the silicon particles 40 vaporize, diffuse through the graphite layer 42 and convert the carbon particles to silicon carbide powder which is manifested by a green-tinged or yellow-tinged color.

Upon completion of the heating process, the workpiece is retained in the oven for a period of approximately 3-hours after the heating elements have been de-energized, to permit a gradual cooling of the sample in an annealing process. The workpiece may then be removed from the oven.

### EXAMPLE 2

This example is the same as in Example 1, except that the sample is heated to a higher temperature of 1600° C. for 45 minutes, rather than a temperature of 1800° C. for 30 minutes. The rest of the procedure is substantially the same as in Example 1.

### EXAMPLE 3

This example is also the same as Example 1, except that the sample is heated to a temperature of 2200° C. in the furnace for a period of about 15 minutes, rather than a temperature of 1800° C. for 30 minutes as in Example 1. The remainder of the procedure is the same as in Example 1.

### EXAMPLE 4

According to a modification of Example 1, the carbon particles may be placed in the bottom of the crucible, and the silicon particles placed thereover, without the graphite sheet, to first liquify the silicon to wet the carbon particles, and then to vaporize the silicon and to react the vapor with the carbon particles, to produce the SiC particles. The remainder of the procedure may be according to any of Examples 1-3.

While the invention has been described with respect to several preferred examples, it will be appreciated that these are set forth merely for purposes of illustrating the invention, and that many other variations, modifications and applications of the invention may be made.

What is claimed is:

1. A method of producing finely-divided particles of silicon carbide (SiC), comprising:
introducing into a furnace a crucible containing a layer of finely-divided particles of carbon and a layer of finely-divided particles of elemental silicon separated by a layer permeable to silicon vapor;
subjecting the interior of the furnace to a vacuum;
and heating said crucible to a sufficiently high temperature for a sufficiently long period of time to vaporize and diffuse the silicon and to react the silicon vapor with the carbon particles to convert them to silicon carbide particles.

2. The method according to claim 1, wherein the quantity of silicon, before heating, exceeds the quantity of carbon by weight.

3. The method according to claim 1, wherein said carbon and silicon are both contained in a graphite crucible when heated within said furnace.

4. The method according to claim 3, wherein said crucible is at least partly open at its upper end to the interior of the furnace to permit excess silicon vapors to escape to the interior of the furnace, and thereby to suppress deposition of silicon on the outer surface of the resulting product.

5. The method according to claim 1, wherein the interior of said furnace is heated to a temperature of 1600-1800° C. for a period of 30-60 minutes.

6. The method according to claim 5, wherein the interior of said furnace is subjected to a vacuum of approximately 10⁻³ Torr.

7. The method according to claim 5, wherein the resulting product, after being heated, is gradually cooled to room temperature over a period of time substantially longer than the heating time, before the resulting product is removed from the furnace.

8. The method according to claim 1, wherein the silicon particles are over the carbon particles in the crucible when heated.

9. The method according to claim 8, wherein the heating is effected at a temperature of 1600° C.-1800° C. for 30-40 minutes.

10. The method according to claim 9, wherein the vacuum is approximately 10⁻³ Torr.

11. The method according to claim 1, wherein said layer permeable to silicon vapor is a graphite sheet.

12. The method according to claim 1, wherein the heating is effected at a temperature of 1600° C.-1800° C. for 30-40 minutes and the vacuum is approximately 10⁻³ Torr.

13. The method according to claim 1, wherein the carbon particles are over the silicon particles in the crucible when heated.

14. Silicon carbide powder produced according to the method of claim 1.
